(19) United States
(12) Patent Application Publication
(10) Pub. No.: US 2026/0018625 A1
(43) Pub. Date: Jan. 15, 2026

(54) FUEL CELL SEPARATOR

(71) Applicant: TOYOTA JIDOSHA KABUSHIKI KAISHA, Toyota-shi (JP)

(72) Inventors: Daichi Miyazaki, Toyota-shi (JP); Takashi Aisaka, Miyoshi-shi (JP)

(73) Assignee: TOYOTA JIDOSHA KABUSHIKI KAISHA, Toyota-shi (JP)

(21) Appl. No.: 19/050,231

(22) Filed: Feb. 11, 2025

(30) Foreign Application Priority Data
Jul. 12, 2024 (JP) 2024-112587

(51) Int. Cl. H01M 8/0228; H01M 8/0206

(52) U.S. Cl. CPC H01M 8/0228; H01M 8/0206

(57) ABSTRACT

The fuel cell separator includes a metal base material, a titanium layer provided on the metal base material, and a carbon layer provided on the titanium layer, in which a ratio of TiC components of a boundary area between the titanium layer and the carbon layer is 70% or less.

### CROSS-REFERENCE TO RELATED APPLICATION

This application claims priority to Japanese Patent Application No. 2024-112587 filed on Jul. 12, 2024, incorporated herein by reference in its entirety.

### BACKGROUND

### 1. Technical Field

The present disclosure relates to a fuel cell separator.

### 2. Description of Related Art

In recent years, fuel cells have been employed as power sources etc. of vehicles. The fuel cells have a stacked structure in which single cells are stacked. A single cell includes a membrane electrode assembly including anode and cathode electrode layers (catalyst layer and gas diffusion layer) on both surfaces of an electrolyte membrane, and separators respectively disposed on both surfaces of the membrane electrode assembly. The fuel cell separators (hereinafter occasionally abbreviated as “separators”) have a function of electrically connecting single cells in series and a function as a partition wall to shut off fluids such as fuel gases from each other. Various studies have been conducted on the separators.

For example, Japanese Unexamined Patent Application Publication No. 2010-153353 (JP 2010-153353 A) discloses a conductive member including a metal base layer and a conductive carbon layer containing conductive carbon positioned on at least one main surface of the metal base layer, in which the D-band peak intensity (I_{D}) and the G-band peak intensity (I_{G}) measured by Raman scattering spectroscopy of the conductive carbon layer have an intensity ratio I_{D}/I_{G} of 1.3 or more. Meanwhile, Japanese Unexamined Patent Application Publication No. 2022-45138 (JP 2022-45138 A) discloses a separator including a metal substrate, a corrosion-resistant metal intermediate layer formed on the metal substrate, and a carbon layer formed on the corrosion-resistant metal intermediate layer, in which I_{D}/I_{G} is 0.70 or more and less than 0.95. Further, Japanese Patent No. 7375723 discloses a fuel cell separator in which a titanium layer containing titanium is deposited on a metal substrate, in which the ratio of the (100) surface to the total sum of values obtained by dividing, by the relative intensity, the peak intensity of the (100) surface, the (002) surface, and the (101) surface derived from titanium in X-ray diffraction analysis of a surface of the separator, represented by the formula{(peak intensity of (100) surface/relative intensity of (100) surface)/[(peak intensity of (100) surface/relative intensity of (100) surface)+ (peak intensity of (002) surface/relative intensity of (002) surface)+ (peak intensity of (101) surface/relative intensity of (101) surface)]}×100, is 16.9% or more.

### SUMMARY

It is required to reduce the contact resistance of the separators in order to ensure conductivity. However, it is difficult to reduce the contact resistance so as to ensure conductivity for a long period of time under the environment in the fuel cell in which the separators are used. Furthermore, in recent years, there has been an increasing demand for fuel cells for commercial vehicles, which are required to have a longer service life than passenger vehicles. For this reason, it is required that conductivity should be ensured over a longer period of time than in the related art.

The present disclosure has been made in view of such an issue, and an object of the present disclosure is to provide a fuel cell separator capable of securing sufficient conductivity.

In order to address the above issue, an aspect of the present disclosure provides a fuel cell separator including: a metal substrate; a titanium layer provided on the metal substrate; and a carbon layer provided on the titanium layer, in which a boundary region between the titanium layer and the carbon layer has a TiC content of 70% or less.

According to the present disclosure, it is possible to secure sufficient conductivity.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1A is a schematic perspective view of a separator according to one embodiment;

FIG. 1B is a schematic cross-sectional view of a separator according to an embodiment;

FIG. 2A is a diagrammatic representation of the photoelectron spectrum (PT) of the sum of Ti2p trajectories obtained by HAXPES analyses for separators of a sample and the spectra (1 to 8) of the respective components obtained by separating the spectra;

FIG. 2B is a table showing a computational example for reference of the orientation ratios of each crystalline lattice surface of a titanium layer;

FIG. 3A is a graphical representation of the change in TiC components versus negative biasing voltage of the substrate during deposition of the carbon-layers of the separators of Samples 1-1 through 1-9;

FIG. 3B is a graphical representation of the change in initial contact resistance and contact resistance after durability for TiC composition ratios of the separators of Samples 1-1 through 1-9;

FIG. 4A is a graphical representation of the change of I_{D}/I_{G} with respect to the negative bias voltage of the substrate during deposition of the carbon layers of the separators of Samples 1-1 to 1-9;

FIG. 4B is a graphical representation of the change in contact-resistance of separators I_{D}/I_{G} for samples 1-1 through 1-9;

FIG. 5A is a photograph showing a TEM view image and a EELS mapped image of the cross section of the titanium-layer and carbon-layer in the convex portion of the flow path shapes for the separators of Samples 2-1 to 2-3;

FIG. 5B is a graphical representation of the change in early contact-resistance with respect to the thickness of the titanium oxide layers of the separators of Samples 2-1 through 2-3;

FIG. 5C is a AES depth profile of separator of sample 2-1;

FIG. 5D is an AES depth profile for the separators of Sample 2-2;

FIG. 6A is a graphical representation of the relationship between the orientation ratio of the (100) plane of the titanium-layer of each of the separators of Samples 3-1 through 3-10 and Fe dissolution rate of a plurality of samples of each of the separators;

FIG. 6B is a graphical representation of the relationship between the orientation ratio of the (002) plane of the titanium-layer of each of the separators of Samples 3-1 through 3-10 and Fe dissolution rate of a plurality of samples of each of the separators;

FIG. 6C is a SEM view of a cross section of a sample in which the orientation ratio of the (100) surface of the titanium layer is less than 16.9% and a sample in which the orientation ratio of the (100) surface of the titanium layer is 16.9% or more, respectively; and

FIG. 6D is a SEM observed images of the cross-section of the sample and the (100) surface orientation ratio of the titanium layer is 16.9% or more of the sample and the (100) surface orientation ratio of the titanium layer is less than 16.9%, respectively.

### DETAILED DESCRIPTION OF EMBODIMENTS

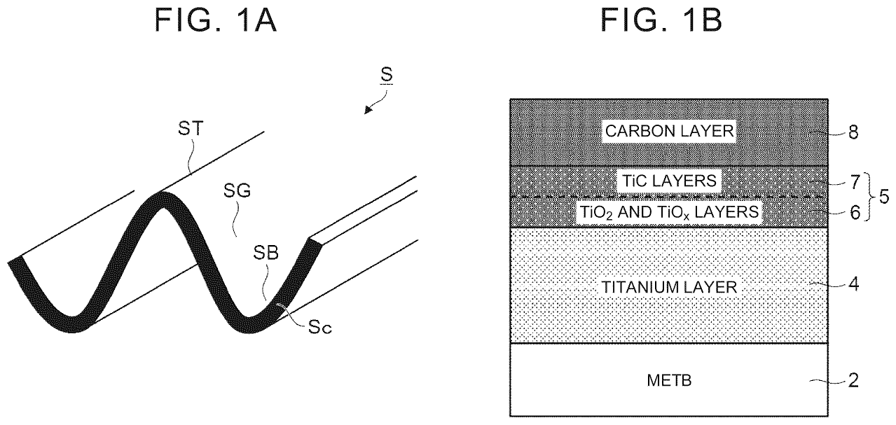

Hereinafter, an embodiment of the fuel cell separator of the present disclosure will be described. FIG. 1A is a schematic perspective view showing a separator according to one embodiment, and FIG. 1B is a schematic cross-sectional view showing a cross-section parallel to the thickness of the layers of the convex part of the separator according to one embodiment.

As shown in 1A, the separator S according to one embodiment has a flow path configuration including a concave portion SB and a convex portion ST extending along the flow path direction of the fluid, and an oblique portion SG therebetween. The cross-sectional Sc perpendicular to the flow path of the separator S has a curved shape corresponding to the flow path shape. As shown in 1B, the separator S includes a metal base material 2 in which a stainless-steel base material is used, a titanium layer 4 provided on the metal base material 2, and a carbon layer 8 provided on the titanium layer 4. The titanium layer 4 contains metallic Ti (titanium), and the carbon layer 8 contains conductive C (carbon).

The titanium layer 4 and the carbon layer 8 are formed by forming a film on the metal base material 2 in this order by, for example, a PVD method. Due to contamination or the like during the forming process of the titanium layer 4 and the carbon layer 8, titanium oxide components such as TiOₓ (x<2) components and TiO₂ components are generated, and there is a possibility that the titanium layer 4 and the carbon layer 8 are arranged in the boundary region 5. In some cases, a titanium oxide layer (TiOₓ layer and TiO₂ layer) 6 including titanium oxide components may be formed in the boundary region 5. In addition, in the process of forming the carbon-layer 8, a TiC component (titanium carbide component) may be generated and disposed in the boundary region 5. In some cases, TiC layers 7 including TiC components may be formed in the boundary regions 5.

In the separator S, in all of the concave portion SB, the convex portion ST, and the oblique portion SG, TiC content of the boundary region 5 is 70% or less. Further, the intensity ratio (I_{D}) of the D-band peak intensity (I_{G}) and the G-band peak intensity (I_{D}/I_{G}) in the Raman spectrum of the carbon layer 8 is 0.7 or more. Further, in all of the concave portion SB, the convex portion ST, and the oblique portion SG, the thickness of the titanium oxide layer 6 in the boundary region 5 is equal to or less than 47 nm, or the maximal O (oxygen) element ratio in the boundary region 5 is 88 atomic % or less. Further, in all of the concave portion SB, the convex portion ST, and the oblique portion SG, the orientation ratio of the (100) plane of the titanium layer 4 is 16.9% or more, and the orientation ratio of the (002) plane of the titanium layer 4 is 61.0% or less.

Conventionally, in an environment in a fuel cell in which a separator is used, for example, in a separator employing a metal base material such as a stainless steel base material, it is difficult to sufficiently ensure durability and corrosion resistance together with conductivity. For this reason, as in the separator S according to one embodiment, a separator formed by depositing a titanium layer for improving durability and corrosion resistance and a carbon layer for improving conductivity on a metal substrate in this order by a PVD method or the like has been used. However, even when such a separator is used in a fuel cell, in an environment in the fuel cell, a condition such as application of potential loads generated during operation to the separator, low pH of generated water containing Cl-ions, Fe ions, and the like, and exposure of the separator to a high-temperature atmosphere (for example, 100° C. or less) persists, whereby TiC components in the boundary regions between the titanium layer and the carbon layer of the separator are oxidized, and thus titanium oxide components may be generated. This can result in delamination of the carbon layer. Therefore, 25 the contact resistance after the durability of the separator may be increased.

On the other hand, in the separator S according to the embodiment, TiC content of the boundary regions 5 of the titanium layer 4 and the carbon layer 8 is 70% or less in all of the concave portion SB, the convex portion ST, and the oblique portion SG. Therefore, the quantity of TiC components in the boundary region 5 is suppressed. Therefore, when the separator S is used in an environment in the fuel cell, TiC component in the boundary region 5 is prevented from being oxidized to form a titanium-oxide component. As a result, the contact resistance of the separator S after the durability is suppressed from increasing. Therefore, the conductivity of the separator S can be sufficiently secured. Further, since I_{D}/I_{G} is equal to or greater than 0.7, the degree of disturbance (graphite cluster amount, size) of the polycrystalline graphite structure of the carbon layer 8 is appropriately secured, and a conductive path from one surface to the other surface of the carbon layer 8 can be secured. Therefore, the initial contact resistance of the separator S is reduced, and the contact resistance after the durability of the separator S is also reduced. Therefore, the conductivity of the separator S can be sufficiently secured. Hereinafter, the configuration of the fuel cell separator according to the embodiment will be described in more detail.

The fuel cell separator includes a metal base material, a titanium layer provided on the metal base material, and a carbon layer provided on the titanium layer. As in the separator S according to one embodiment, the separator generally has a flow path configuration for delivering a fluid such as a fuel gas (H₂(hydrogen)), an oxidant gas (O₂ (oxygen)), and a coolant. The flow path shape of the separator is, for example, a shape including a concave portion (bottom portion) and a convex portion (top portion) extending along the flow path direction of the fluid, and an oblique portion therebetween.

The metal base material is not particularly limited, but may be, for example, a metal base material made of a metal cheaper than Ti(Ti). Specific examples thereof include metallic substrates composed of Fe (iron), Al (aluminum), alloys thereof, and the like, and among them, stainless-steel substrates are preferable. This is because the electrical conductivity of the contact surface can be sufficiently ensured. The stainless steel base material is not particularly limited, and examples thereof include an austenitic material and a ferritic material. The thickness of the metallic substrate is, for example, from 0.05 mm to 1 mm. When the thickness falls within this range, it is easy to satisfy requirements for weight reduction, thickness reduction, and strength, and ease of processing. The metal substrate is usually formed with a flow path shape for delivering a fluid such as a fuel gas, an oxidant gas, or a cooling medium in a separator. The flow path shape of the metal base material is a shape corresponding to the flow path shape of the separator, and is, for example, a shape including a concave portion and a convex portion extending along the flow path direction of the fluid and an oblique portion therebetween. The height difference between the concave portion and the convex portion in the flow path shape of the metal base material is, for example, 10 μm to 500 μm except for the thickness of the metal base material. In the separator, since the thickness of the titanium layer and the carbon layer is thinner than the thickness of the metal base material, the flow path shape of the separator depends on the flow path shape of the metal base material.

The titanium layer is not particularly limited as long as it is a layer containing Ti (titanium), for example, (100) plane derived from Ti in X-ray diffraction analysis of the surface of the separator, (002) plane, and (101) plane relative intensity of the peak of the peak (theoretical diffraction intensity) to the sum of the values obtained by dividing the peak intensity by the relative intensity of the peak (100) plane ratio of the value obtained by dividing the peak intensity by the relative intensity of the peak (orientation ratio of (100) plane of the titanium layer) is 16.9% or more, and the ratio of the value obtained by dividing the peak intensity of (002) plane relative intensity of the peak to the total by the relative intensity of the peak (orientation ratio of (002) plane of the titanium layer) is preferably 61.0% or less. Among them, the orientation ratio of the (100) plane of the titanium layer is preferably 20.0% or more, and the orientation ratio of the (002) plane of the titanium layer is preferably 40.0% or less. This is because the titanium layer is dense and has a flat structure with few defects, so that the corrosion resistance of the separator can be improved. Specifically, this is because corrosion is generated by infiltration of water generated from defects in the titanium-layer to the metal substrate, Fe can be suppressed from being eluted, and poisoning of the electrolyte film due to elution of Fe can be prevented.

The separator may satisfy, at least in part, the above-described condition of the orientation ratio, but in particular, the separator preferably satisfies the above-described condition of the orientation ratio at the convex portion of the flow path shape. This is because the convex portion has a large influence on contact resistance and the like.

The titanium layer may be a layer comprising a metallic Ti or a Ti alloy. In addition to Ti, the titanium layers may include, for example, N (nitrogen), C (carbon), H (hydrogen), O (oxygen), Fe (iron), Al (aluminum), V (vanadium), and the like. The thickness of the titanium-layer is not particularly limited, but is, for example, 800 nm from 10 nm, and can be calculated, for example, as a mean of cross-sectional SEM (scanning electron-microscope) observations.

The carbon layer is not particularly limited as a conductive carbon layer including conductive C (carbon), but as the carbon layer 8 according to an embodiment, the intensity ratio (I_{D}/I_{G}) of the D band peak intensity (I_{D}) and the G band peak intensity (I_{G}) in the Raman spectrum D is preferably 0.7 or more, in particular, I_{D}/I_{G} is preferably 0.94 or more and 1.00 or less. This is because when I_{D}/I_{G} is greater than or equal to the lower limit of these ranges, the initial contact resistance of the separator is reduced, and when I_{D}/I_{G} is less than or equal to the upper limit of this range, the increase in the contact resistance of the separator in the fuel cell can be suppressed.

When the carbon-material is analyzed by Raman spectroscopy, peaks generally occur around the wavelength 1350 cm-1 and around 1550 cm-1. Highly crystalline graphite has a peak around the wave 1550 cm-1, and this peak is commonly referred to as the “G-band peak”. On the other hand, as the crystallinity becomes lower (crystal-structure-defect increases), a peak appears in the vicinity of the wavelength 1350 cm⁻¹. This peak is commonly referred to as the “D-band peak.” The D-band peak intensity (I_{D}) and the G-band peak intensity (I_{G}) respectively used as indices of the ratio of sp2 bonding and sp3 bonding in the carbon layer (I_{D}/I_{G}) are used as indices of the degree of disorder (crystal structure deficiency), sp2 bonding ratio, and the like of the polycrystalline graphite structure of the carbon material. That is, I_{D}/I_{G} is used as an index of the contact-resistance of the carbon layer and a film-like parameter for controlling the conductivity of the carbon layer. I_{D}/I_{G} is calculated using a Raman spectrometer to obtain a Raman spectrum of the carbonaceous material. In detail, it is determined by calculating a relative intensity ratio (a peak intensity ratio (I_{D}/I_{G})) of a D band peak intensity (I_{D}) called “D band” from a wavelength 1300 cm⁻¹ to 1400 cm⁻¹ region, and a G band peak intensity (I_{G}) called “G band” from a wavelength 1500 cm⁻¹ to 1600 cm⁻¹ region. As the separator, at least in part, I_{D}/I_{G} may be equal to or greater than 0.7, but in particular, it is preferable that I_{D}/I_{G} is equal to or greater than 0.7 in the channel-shaped convex part. This is because the convex portion has a large influence on contact resistance and the like. The thickness of the carbon-layer is not particularly limited, but is, for example, 500 nm from 10 nm, and can be calculated, for example, as a mean obtained by observing SEM of the cross section.

The separator has a TiC component ratio (hereinafter, sometimes abbreviated as “TiC component ratio”) of 70% or less in a border area between the titanium layer and the carbon layer. TiC component ratio can be calculated, for example, as the ratio [%] of the integrated area of the spectrum of the separated TiC to the sum of the integrated areas of the spectra of all separated components after separating the photoelectron spectrum (PT) of the sum of Ti2p trajectories obtained by analyzing the separators by HAXPES into the spectra of the respective components, as described in the embodiments described below. The separator preferably has, at least in part, a TiC component ratio of 70% or less, and more preferably has, at least in part, a TiC component ratio of 70% or less at the channel-shaped convex part. This is because the convex portion has a large influence on contact resistance and the like.

Although it is not particularly limited as the separator, as the separator S according to the embodiment, the thickness of the titanium oxide layer (the sum of the thickness of TiOₓ layer and TiO₂ layer, and hereinafter, this may be abbreviated as “thickness of the titanium oxide layer.”) in the interface region of the titanium layer and the carbon layer is preferably 47 nm or less, or a maximum value of an O (oxygen) element ratio (hereinafter, this may be abbreviated as “maximum value of an O element ratio”) in the interface regions of the titanium layer and the carbon layer is preferably 88 atomic % or less. This is because, by reducing the titanium oxide component in the boundary region between the titanium layer and the carbon layer, the conduction path between the titanium layer and the carbon layer can be sufficiently secured, so that the conductivity of the separator can be further improved. The thickness of the titanium oxide layer can be calculated, for example, by acquiring TEM observed images and EELS mapped images of the titanium layer and the cross-section of the carbon layer (cross-section parallel to the thickness direction of the layer) of the separators, as described in the embodiments described below, and then averaging the total thickness of TiOₓ layer and TiO₂ layer from these images. Further, the maximum value of the O element ratio can be calculated as the maximum value [atomic %] of the O element ratio in the thickness direction in the border area from AES depth profile by analyzing the depth direction (thickness direction of the layer) by AES from the surface of the carbon layer of the separator, and creating the AES depth profile, for example, as described in the embodiment to be described later. The thickness of the titanium oxide layer is preferably 47 nm or less in at least a part of the separators, but in particular, the thickness of the titanium oxide layer is preferably 47 nm or less in the channel-shaped convex part. This is because the convex portion has a large influence on contact resistance and the like. Further, as the separator, at least in part, the maximum value of the O element ratio is preferably 88 atomic % or less, particularly in the convex portion of the flow path shape, the maximum value of the O element ratio is preferably 88 atomic % or less. For the same reason.

The separator is a component of a single cell of a fuel cell, and is disposed on both surfaces of a membrane electrode assembly (an anode and a cathode electrode layer disposed on both surfaces of an electrolyte membrane and an electrolyte membrane). Examples of the method for manufacturing the separators include a manufacturing method including a step of forming a titanium layer on a metallic substrate by a PVD method (physical vapor deposition method) such as UBMS (unbalanced magnetron sputtering), and a step of forming a carbon layer on the titanium layer by a PVD method such as AIP (arc ion plating). As a method of adjusting TiC content ratio of the boundary regions to 70% or less, and a method of adjusting the I_{D}/I_{G} of the carbon layer to 0.7 or more, for example, a method of adjusting the negative bias voltage of the metal substrate (titanium layer) to a predetermined range when the carbon layer is formed on the titanium layer by AIP is exemplified. Examples of the method for adjusting the thickness of the titanium oxide layer in the boundary region to be equal to or less than 47 nm, and the processing method for adjusting the maximum value of the O element ratio in the boundary region to be equal to or less than 88 atomic %, include, for example, a method for suppressing contamination by oxygen atoms in the boundary region by increasing the degree of vacuum in the reaction vessel during the film formation of the titanium layer while sufficiently removing adsorbed moisture and residual moisture in the reaction vessel by preheating or the like prior to the film formation of the titanium layer. Examples of the method of adjusting the orientation ratio of the (100) plane of the titanium layer to 16.9% or more and the orientation ratio of the (002) plane of the titanium layer to 61.0% or less include a method of adjusting UBM coil current value for controlling the strength of the plasma when the titanium layer is formed on the metal substrate by UBMS, a negative bias voltage of the metal substrate, and the like to a predetermined range.

Hereinafter, the fuel cell separator according to the embodiment will be described in more detail with reference to Examples, Comparative Examples, and Reference Examples.

1. Preparation of samples

### Sample 1-1

The separator of Sample 1-1 was prepared by the following preparation method. First, as a metallic base material, a stainless-steel base material (SUS304) having a thickness 0.1 mm in which channel shapes of separators were formed was prepared. Next, a PVD deposition device was used to deposit a titanium-layer and a carbon-layer on the metallic substrate in this order.

In this case, the metal substrate was first placed in the reactor vessel of the apparatus and the reactor vessel was evacuated. Subsequently, in order to form a titanium layer, the temperature in the reaction vessel was raised to the processing temperature by an internal heater. Next, the pure Ti cathode target used for sputtering was etched (cleaned) with the plasmatized Ar gases. In addition, the surface of the metallic substrate was etched with the plasmatized Ar gases to remove any passivation present on the surface. Next, a pure Ti cathode target was used to form a titanium-layer on the metallic substrate by UBMS. The film formation conditions are as follows.
Target film thickness: 220 nm
Deposition time: 41 minutes
Treatment temperature: 150° C.Degree of vacuum: 2E-03 mbar
Input gas: Ar
Gas flow rate: 250 sccm
Board biasing: PLS (pulsed)
Board Negative Bias-Voltage: 150V
Frequency: 40 kHz
Off time in frequency: 5 μS
Target biasing species: DC
Ti cathode power: 8 kW/A/V
UBM current: 2A
Revolution rate: 3 rpm

Subsequently, in order to form a carbon layer, the temperature in the reaction vessel was adjusted to the processing temperature by an internal heater. Next, using a high-purity ta-C raw material, a carbon-layer was formed on the titanium-layer by AIP. The film formation conditions are as follows.
Target film thickness: 25 nm
Deposition time: 1 minute
Treatment temperature: 180° C.
Degree of vacuum: 2E-03 mbar
Input gas: Ar
Gas flow rate: 250 sccm
Board biasing: PLS (pulsed)
Board Negative Bias-Voltage: 0V
Frequency: 40 kHz
Off time in frequency: 5 μS
Target biasing species: DC
C Cathode Power: 60 kW/A/V
Revolution rate: 4 rpm

Thus, the separator of Sample 1-1 was prepared.

### Samples 1-2 to 1-9

The separators of Samples 1-2 to 1-9 were manufactured by the same manufacturing method as that of the separator of Sample 1-1 except that the negative bias voltage of the substrate at the time of forming the carbon layer was changed as shown in Tables 1 to 3 below.

### Sample 2-1

The separator of Sample 2-1 was manufactured by the same manufacturing method as that of the separator of Sample 1-1 except that the negative bias voltage of the substrate at the time of film formation of the carbon layer was changed as shown in Tables 1 to 3 below, and that the processing temperature in the reaction vessel during film formation of the titanium layer was changed.

### Samples 2-2 and 2-3

The separators of Samples 2-2 and 2-3 were manufactured by the same manufacturing method as the separator of Sample 2-1 except that the processing temperature in the reaction vessel during the deposition of the titanium layer was changed.

### Sample 3-1

The separator of Sample 3-1 was manufactured by the same manufacturing method as that of the separator of Sample 1-1 except that the negative bias voltage of the substrate at the time of film formation of the titanium layer and the negative bias voltage of the substrate at the time of film formation of the carbon layer were changed as shown in Tables 1 to 3 below.

### Samples 3-2 to 3-10

The separators of Samples 3-2 to 3-10 were manufactured by the same manufacturing method as the separator of Sample 3-1 except that the negative bias voltage of the substrate at the time of film formation of the titanium layer was changed as shown in Tables 1 to 3 below.

### 2. Evaluation

For the separators of Samples 1-1 to 1-9, Samples 2-1 to 2-3, and Samples 3-1 to 3-10, the thicknesses of the titanium-layer and the carbon-layer (averaged by SEM observations of the cross-section) were measured. The results are shown in Tables 1 to 3 below. Further, the evaluation was performed as follows.

### TiC Content of the Interface Between the Titanium-Layer and the Carbon-Layer

For the separators of samples 1-1 to 1-9, samples 2-1 to 2-3, and samples 3-1 to 3-10, TiC components ratio [%] of the border regions of the titanium-layer and the carbon-layer in the convex portion (the top portion) of the channel shape were determined. First, the separators were analyzed by hard X-ray photoelectron spectroscopy (HAXPES). The analyses were carried out in the beamline BL16XU of a large radiant facility SPring-8. In the beamline, monochromatization was carried out by Si(111) 2 crystal spectrometer and Si (444) channel-cut crystal spectrometer. In the analysis, the carbon layer side was irradiated with hard X-rays. Then, the thickness of the carbon layer was adjusted to a predetermined thickness, and the X-ray energy was set to 8 keV and the extraction angle was set to 80°, so that the border area between the titanium layer and the carbon layer was set as the measuring area. Analytical conditions are as follows.
X-ray energy: 8ke V
Energy-width: 250me V
Pass energy: 200e V
Beam size: Approx. 150 μm×35 μm (bend cylindrical mirror (horizontal condensing+vertical condensing))
Measuring time: Per 200 ms/1 point
Spacing: 50me V
Spectrum: Ti (Titanium) 2p
Extraction angle: 80°
Analyzer: R4000 manufactured by VGScienta Corporation

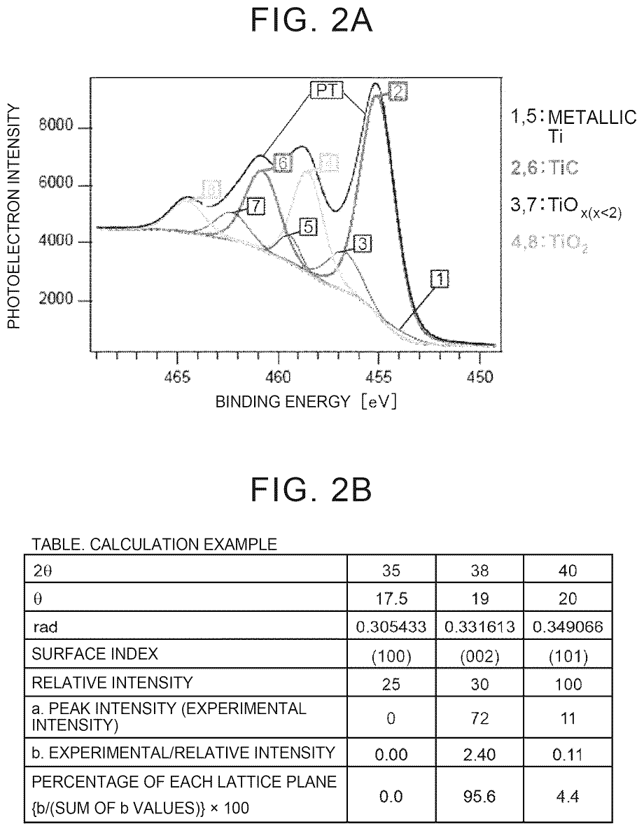

FIG. 2A is a graph schematically showing the photoelectron spectrum (PT) of the sum of Ti2p trajectories obtained by analyzing the separators of one sample by HAXPES and the spectra (1 to 8) of the respective components obtained by separating the spectra. The abscissa and ordinate of the graph indicate the binding energy and the normalized photoelectron intensity, respectively. By analyzing by HAXPES, the photoelectron spectra (PT) of the sum of Ti2p trajectories of the respective samples were obtained as shown in FIG. 2A. Next, using a software PHIMultiPak manufactured by ULVAC FI CORPORATION, based on the Shirley method, the photoelectron spectrum (PT) of the sum of Ti2p trajectories was separated into a spectrum (1, 5) of metallic Ti, a spectrum (2, 6) of TiC, a spectrum (3, 7) of TiOₓ, and a spectrum (4, 8) of TiO₂, excluding the background, as shown in FIG. 2A. Then, the integrated areas of the spectra of all these separated components were respectively calculated. Then, the ratio [%] of the integrated area of TiC spectrum (2, 6) to the sum of the integrated areas of the spectra of all components was calculated as TiC component ratio. The results are shown in Tables 1 to 3 below. I_{D}/I_{G} in Raman spectrum of carbon-layer

For the separators of the samples 1-1 to 1-9, the samples 2-1 to 2-3, and the samples 3-1 to 3-10, the intensity ratio (I_{D}/I_{G}) between the D-band peak intensity (I_{D}) and the G-band peak intensity (I_{G}) in the Raman spectrum of the carbon layer in the convex portion of the channel shape were determined. First, the carbon-layer was analyzed using a HORIBA Raman spectrometer Xplolaplus to obtain a Raman spectrum. Next, the Raman spectrum was subjected to baseline correction, and smoothing was performed by taking a moving average of five peak intensity data points. Next, the simple peak intensity of the wavelength 1350 cm⁻¹ was obtained as I_{D}, and the maximum simple peak intensity of 1600 cm⁻¹ domain was obtained from the wavelength 1500 cm⁻¹ as I_{G}. Next, I_{D} and I_{G} were calculated from I_{D}/I_{G}. The results are shown in Tables 1 to 3 below. Maximum value of the thickness and the O element ratio of the titanium oxide layer in the boundary region between the titanium layer and the carbon layer

The separators of the samples 2-1 to 2-3 were observed by TEM (transmission electron microscopy) on the cross section of the titanium layer and the carbon layer (cross section parallel to the thickness direction of the layer) in the convex portion of the channel shape. TEM observed image and EELS mapped image of the cross section were obtained by performing composition analysis by EELS (electron energy loss spectroscopy) on TEM observed image. From EELS mapped images, the mean thickness (thickness of the titanium oxide layer) of the sum of TiOₓ layer and TiO₂ layer, which is the titanium oxide layer in the border regions of the titanium layer and the carbon layer, was calculated. The results are shown in Tables 1 to 3 below. AES depth profile was obtained from AES depth profile by analyzing the depth direction (thickness direction of the layer) by Auger Electron Spectroscopy (AES) from the surface of the carbon-layer in the convex part of the channel shape. The maximum value [atomic %] of the O (oxygen) element ratio in the thickness direction in the border region was obtained. The results are shown in Tables 1 to 3 below. Orientation ratio of the crystal lattice plane of the titanium layer

For each of the separators of Samples 1-1 to 1-9 and Samples 3-1 to 3-10, the orientation ratios [%] of the (100) plane, the (002) plane, and the (101) plane, which are the crystal lattice planes of the titanium layer in the convex portion of the channel shape, were calculated by the following procedure. Note that, in 2B shown in the drawings, the orientation ratio of the crystal lattice planes of the titanium layer is calculated as a reference.
(1) Using an X-ray diffraction analyzer SmartLab (X-ray: CuKα) manufactured by Rigaku Corporation, the separators were analyzed by XRD (X-ray diffraction).
(2) The peaks of the (100) plane, the (002) plane, and the (101) plane, which are the main diffracted peaks of the titanium layer detected by XRD spectrometry, were fitted with a device, and the peak intensities (experimental intensities) of the crystal lattice planes of the titanium layer were calculated.
(3) Since the peak intensity differs depending on the crystal lattice plane and the relative intensity is present, the peak intensity of each crystal lattice plane of the titanium layer was divided by the relative intensity (theoretical diffraction intensity) of the peak of each crystal lattice plane.
(4) The (peak intensity/relative intensity) of each crystal lattice plane of the titanium layer obtained in (3) was further divided by the sum of (peak intensity/relative intensity) of all of the above-described crystal lattice planes of the titanium layer, and the orientation ratio [%] of each crystal lattice plane of the titanium layer was calculated by expressing it by a 100 fraction.

the calculation results are shown in Tables 1 to 3 below. In the separator of the sample in which the orientation ratio of the (100) plane of the titanium layer is less than 16.9% and the separator of the sample in which the orientation ratio of the (100) plane of the titanium layer is 16.9% or more, the cross section (cross section parallel to the thickness of the layer) at each convex part was observed by SEM (scanning-electron microscopy). Initial contact resistance

Initial contact resistance was determined for the separators of samples 1-1 to 1-9, samples 2-1 to 2-3, and samples 3-1 to 3-10. First, a carbon sheet (a TGP-H-060 manufactured by Toray Industries, Inc.) used as a GDL (a gas-diffusion layer) was placed on the surface of the carbon layer of the separator, and a constant load (1 MPa) was applied by a measuring tool, so that a current value flowing through the separator by an ammeter became 1A, and the current from the power source was adjusted and passed, and the voltage value applied between the separator and the carbon sheet was measured by a voltmeter. Next, the initial contact resistance [m Ω·cm²] was calculated by converting the voltage value into a resistance value and multiplying the evaluation area. The results are shown in Tables 1 to 3 below.

### Fe Dissolution Rate

For the separators of the samples 1-1 to 1-9 and the samples 3-1 to 3-10, one or a plurality of samples having a predetermined shape were cut out in plan view, and an elution test simulating a corrosive environment was performed on each sample, and Fe elution rate of each sample was determined. One sample (n1) was cut out from the separators of Samples 1-1 to 1-9 to perform the test, and Fe elution rate of one sample was determined. Three samples (n3 from n1) were cut out from the separators of Samples 3-1, 3-2, 3-4, and 3-6 to 3-10 to perform the test, and Fe elution rates of the three samples were determined. Thirteen samples (n13 from n1) were excised from the separators of Samples 3-3 and tested to determine Fe elution rates of the thirteen samples. Four samples (n4 from n1) were cut from the separators of Samples 3-5 and tested to determine Fe elution rates of the four samples. At this time, first, as a dissolution test, a constant potential erosion test according to JISZ2294 was performed. Specifically, a test was conducted in which the samples were immersed in an aqueous solution of sulfuric acid adjusted to 80° C., and the potential of 0.9VvsSHE was kept constant for 60 hours. In the test, as the sulfuric acid aqueous solution, a solution in which NaF was dissolved so that the fluoride ionic concentration became 3 ppm was used. Then, Fe amounts (weights) in the sulfuric acid aqueous solution before and after the test were measured by an ICP analyzer. Next, the difference in the amount of Fe in the sulfuric acid aqueous solution before and after the test was calculated, and the difference in the amount of Fe was converted into the amount of material, and Fe elution rate [10-10 mol/cm²/hr] was calculated by dividing the difference by the test time and the evaluated area. The results are shown in Tables 1 to 3 below, the contents of which will be described later.

Contact Resistance after Durability

For each of the separators of Samples 1-1 to 1-9, the contact resistance after durability was determined. First, as a durability test, a dissolution test similar to the dissolution test when Fe dissolution rate was determined was performed on the separators. Then, for the separators 240 hours after the test was performed, the contact resistance [m2. cm²] after the durability was determined in the same manner as the initial contact resistance. The results are shown in Tables 1 to 3 below.

TABLE 1

| | Substrate for | Substrate for | | | | | Titanium | Maximum |
|---|---|---|---|---|---|---|---|---|
| | forming a titanium | forming a | Titanium | Carbon | | | oxide | oxygen |
| | layer Negative | carbon layer | layer | layer | TiC | | layer | element |
| | bias voltage | Negative bias | thickness | thickness | Component | I_{D}/I_{G} | thickness | ratio |
| Sample | [-V] | voltage [-V] | [nm] | [nm] | ratio [%] | [—] | [nm] | [Atomic %] |
| Sample 1-1 | 150 | 0 | 220 | 33 | 37.8 | 0.94 | — | — |
| Sample 1-2 | 150 | 10 | 220 | 30 | 38.7 | 0.70 | — | — |
| Sample 1-3 | 150 | 20 | 218 | 31 | 43.5 | 0.68 | — | — |
| Sample 1-4 | 150 | 50 | 220 | 32 | 49.2 | 0.86 | — | — |
| Sample 1-5 | 150 | 100 | 221 | 31 | 59.5 | 0.99 | — | — |
| Sample 1-6 | 150 | 150 | 228 | 32 | 63.5 | 1.01 | — | — |
| Sample 1-7 | 150 | 170 | 240 | 34 | 65.0 | 1.00 | — | — |
| Sample 1-8 | 150 | 200 | 230 | 29 | 70.0 | 1.01 | — | — |
| Sample 1-9 | 150 | 250 | 230 | 30 | 72.0 | 1.04 | — | — |
| Sample 2-1 | 150 | 250 | 220 | 20 | 23.2 | 1.02 | 5 | 3 |
| Sample 2-2 | 150 | 250 | 220 | 25 | 10.0 | 1.04 | 47 | 88 |
| Sample 2-3 | 150 | 250 | 220 | 23 | 8.0 | 1.03 | 57 | 92 |
| Sample 3-1 | 75 | 250 | 210 | 51 | 72.5 | 1.02 | — | — |
| Sample 3-2 | 75 | 250 | 230 | 52 | 72.2 | 1.03 | — | — |
| Sample 3-3 | 100 | 250 | 230 | 51 | 71.3 | 1.04 | — | — |
| Sample 3-4 | 100 | 250 | 210 | 55 | 71.0 | 1.03 | — | — |
| Sample 3-5 | 100 | 250 | 210 | 50 | 72.2 | 1.03 | — | — |
| Sample 3-6 | 100 | 250 | 210 | 47 | 70.9 | 1.03 | — | — |
| Sample 3-7 | 100 | 250 | 210 | 48 | 72.0 | 1.04 | — | — |
| Sample 3-8 | 130 | 250 | 240 | 50 | 73.2 | 1.03 | — | — |
| Sample 3-9 | 150 | 250 | 260 | 51 | 71.5 | 1.04 | — | — |
| Sample 3-10 | 150 | 250 | 214 | 53 | 70.9 | 1.03 | — | — |

[symbol]

1 The “—” of a cell means that there is no data such as measured values.

TABLE 2

| | Crystal lattice plane orientation ratio | | | | |
|---|---|---|---|---|---|
| | of the titanium layer | | | Contact resistance | |
| | [%] | | | [mΩ · cm²] | |
| | (100) | (002) | (101) | Early | After |
| Sample | Face | Face | Face | stage | durability |
| Sample 1-1 | 75.1 | 13.0 | 11.7 | 1.7 | 3.4 |
| Sample 1-2 | 68.0 | 15.0 | 17.0 | 2.9 | 3.8 |
| Sample 1-3 | 90.0 | 5.8 | 4.3 | 17.4 | 20.1 |
| Sample 1-4 | 85.8 | 9.9 | 4.3 | 3.1 | 4.6 |
| Sample 1-5 | 56.3 | 18.5 | 25.2 | 1.7 | 2.3 |
| Sample 1-6 | 78.4 | 14.7 | 6.9 | 1.8 | 2.1 |
| Sample 1-7 | 86.4 | 9.3 | 4.3 | 1.5 | 2.1 |
| Sample 1-8 | 83.1 | 14.9 | 2.0 | 1.5 | 8.3 |
| Sample 1-9 | 56.3 | 18.5 | 25.2 | 1.5 | 208.0 |
| Sample 2-1 | — | — | — | 1.6 | — |
| Sample 2-2 | — | — | — | 1.4 | — |
| Sample 2-3 | — | — | — | 3.1 | — |
| Sample 3-1 | 8.5 | 75.8 | 15.7 | 1.2 | — |
| Sample 3-2 | 7.1 | 83.0 | 10.0 | 1.3 | — |
| Sample 3-3 | 6.1 | 74.1 | 19.8 | 1.1 | — |
| Sample 3-4 | 11.0 | 78.7 | 10.3 | 1.3 | — |
| Sample 3-5 | 17.4 | 61.1 | 21.4 | 1.4 | — |
| Sample 3-6 | 16.9 | 67.7 | 15.4 | 1.3 | — |
| Sample 3-7 | 14.9 | 69.8 | 15.3 | 1.5 | — |
| Sample 3-8 | 27.8 | 51.7 | 20.5 | 1.4 | — |
| Sample 3-9 | 34.1 | 36.7 | 29.2 | 1.5 | — |
| Sample 3-10 | 33.8 | 37.5 | 28.7 | 1.5 | — |

[symbol]

1 The “—” of a cell means that there is no data such as measured values.

TABLE 3

| | Fe dissolution rate | | | | | | | |
|---|---|---|---|---|---|---|---|---|
| | [10⁻¹⁰ mol/cm²/hr] | | | | | | | |
| Sample | n1 | n2 | n3 | n4 | n5 | n6 | n7 | |
| Sample 1-1 | 0.23 | — | — | — | — | — | — | |
| Sample 1-2 | 0.35 | — | — | — | — | — | — | |
| Sample 1-3 | 0.33 | — | — | — | — | — | — | |
| Sample 1-4 | 0.31 | — | — | — | — | — | — | |
| Sample 1-5 | 0.43 | — | — | — | — | — | — | |
| Sample 1-6 | 0.15 | — | — | — | — | — | — | |
| Sample 1-7 | 0.22 | — | — | — | — | — | — | |
| Sample 1-8 | 0.23 | — | — | — | — | — | — | |
| Sample 1-9 | 0.35 | — | — | — | — | — | — | |
| Sample 2-1 | — | — | — | — | — | — | — | |
| Sample 2-2 | — | — | — | — | — | — | — | |
| Sample 2-3 | — | — | — | — | — | — | — | |
| Sample 3-1 | 0.63 | 0.13 | 4.43 | — | — | — | — | |
| Sample 3-2 | 0.87 | 1.02 | 0.98 | — | — | — | — | |
| Sample 3-3 | 1.46 | 0.46 | 6.73 | 3.95 | 0.77 | 1.06 | 0.68 | |
| Sample 3-4 | 0.44 | 0.22 | 0.43 | — | — | — | — | |
| Sample 3-5 | 0.19 | 0.52 | 1.23 | 0.49 | — | — | — | |
| Sample 3-6 | 0.34 | 0.33 | 0.36 | — | — | — | — | |
| Sample 3-7 | 1.28 | 0.98 | 6.34 | — | — | — | — | |
| Sample 3-8 | 0.23 | 0.18 | 0.33 | — | — | — | — | |
| Sample 3-9 | 0.07 | 0.46 | 0.19 | — | — | — | — | |
| Sample 3-10 | 0.20 | 0.18 | 0.37 | — | — | — | — | |
| | | Fe dissolution rate | | | | | | |
| | | [10⁻¹⁰ mol/cm²/hr] | | | | | | |
| | Sample | n8 | n9 | n10 | n11 | n12 | n13 | Remarks |
| | Sample 1-1 | — | — | — | — | — | — | Examples |
| | Sample 1-2 | — | — | — | — | — | — | Examples |
| | Sample 1-3 | — | — | — | — | — | — | Comparative Example |
| | Sample 1-4 | — | — | — | — | — | — | Examples |
| | Sample 1-5 | — | — | — | — | — | — | Examples |
| | Sample 1-6 | — | — | — | — | — | — | Examples |
| | Sample 1-7 | — | — | — | — | — | — | Examples |
| | Sample 1-8 | — | — | — | — | — | — | Examples |
| | Sample 1-9 | — | — | — | — | — | — | Comparative Example |
| | Sample 2-1 | — | — | — | — | — | — | Examples |
| | Sample 2-2 | — | — | — | — | — | — | Examples |
| | Sample 2-3 | — | — | — | — | — | — | Examples |
| | Sample 3-1 | — | — | — | — | — | — | Reference Example |
| | Sample 3-2 | — | — | — | — | — | — | Reference Example |
| | Sample 3-3 | 0.30 | 1.66 | 0.21 | 1.69 | 0.98 | 0.21 | Reference Example |
| | Sample 3-4 | — | — | — | — | — | — | Reference Example |
| | Sample 3-5 | — | — | — | — | — | — | Reference Example |
| | Sample 3-6 | — | — | — | — | — | — | Reference Example |
| | Sample 3-7 | — | — | — | — | — | — | Reference Example |
| | Sample 3-8 | — | — | — | — | — | — | Reference Example |
| | Sample 3-9 | — | — | — | — | — | — | Reference Example |
| | Sample 3-10 | — | — | — | — | — | — | Reference Example |

[symbol]

1 The “—” of a cell means that there is no data such as measured values.

### 3. Consideration of Evaluation Results

Based on the assessment, the relation between the composition of the separator and the contact resistance and Fe elution rate was examined as follows.

### Relation Between TiC Composition Ratio and Contact-Resistance

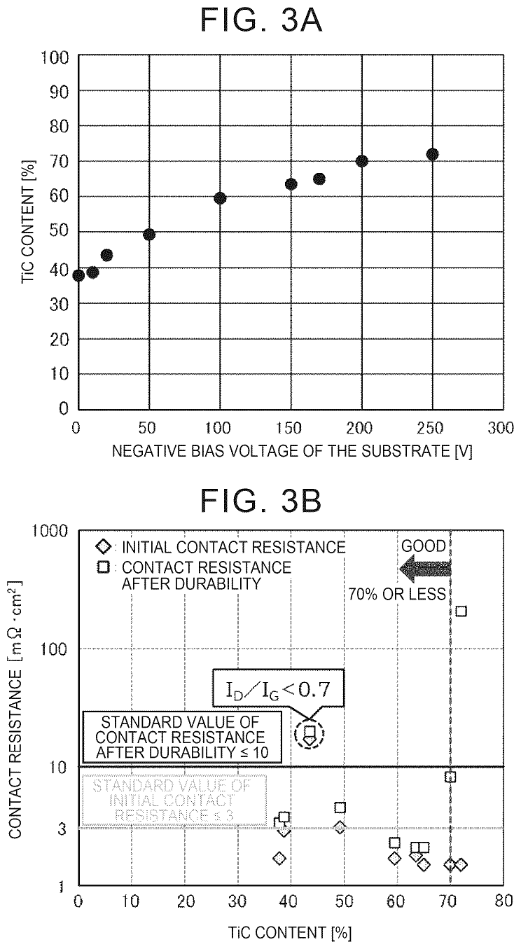

FIG. 3A is a graph showing the change in TiC component ratio with respect to the negative bias voltage of the substrate during the deposition of the carbon layer of the separator of Samples 1-1 to 1-9, and FIG. 3B is a graph showing the change in the contact resistance and the contact resistance after durability of the separator of Samples 1-1 to 1-9 with respect to TiC component ratio. As shown in FIG. 3A and Tables 1 to 3, TiC content increased as the negative bias-voltage of the substrate increased. As shown in FIG. 3B and Tables 1 to 3, when TiC content ratio exceeds 70%, the contact-resistance after durability significantly increased and exceeded the specification value (≤10 m Ω·cm²). From this, it is considered that TiC content is 70% or less. Incidentally, as shown in FIG. 3B and Tables 1 to 3, in Sample 1-3, although TiC content is 43.5% or less of 70%, the initial contact-resistance becomes 17.4 m Ω·cm² and exceeds the specification (≤3 m Ω·cm²). This may be due to the I_{D}/I_{G} being less than 0.7, as described below.

I_{D}/I_{G}

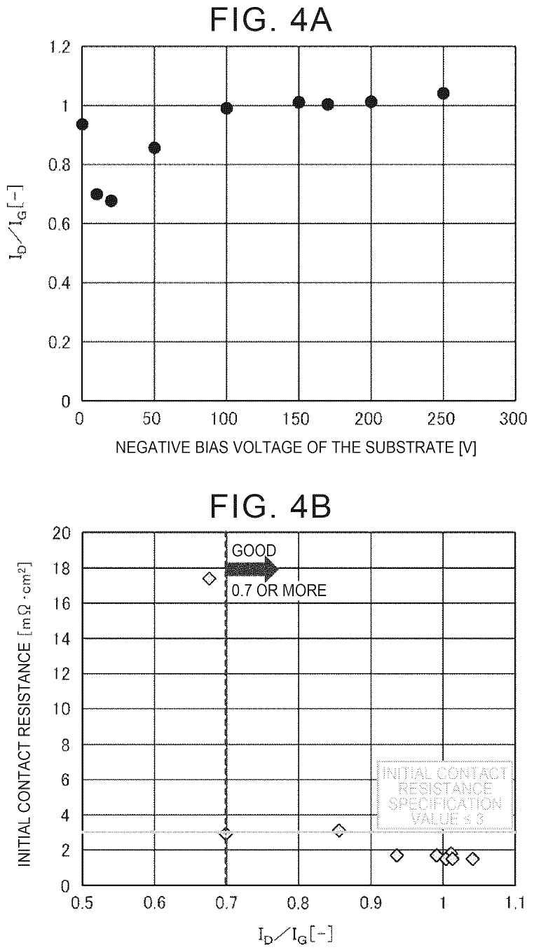

FIG. 4A is a graph showing the change in I_{D}/I_{G} with respect to the negative bias voltage of the substrate during the deposition of the carbon layers of the separators of Samples 1-1 to 1-9, and FIG. 4B is a graph showing the change in the initial contact-resistance to I_{D}/I_{G} of the separators of Samples 1-1 to 1-9. As shown in FIG. 4A and Tables 1 to 3, when the negative bias voltage of the substrate during the deposition of the carbon layer is equal to or higher than 50V, the negative bias voltage increases, so that the I_{D}/I_{G} increases. As shown in FIG. 4B and Tables 1 to 3, when I_{D}/I_{G} is greater than or equal to 0.7, the initial contact-resistance is generally within the specification. From this, it is considered that I_{D}/I_{G} is better than 0.7. From the above, a separator having a TiC content of 70% or less and I_{D}/I_{G} of 0.7 or more is considered to be preferable because the initial contact resistance and the contact resistance after durability fall within the specification. Relationship between thickness and contact resistance of titanium oxide layer

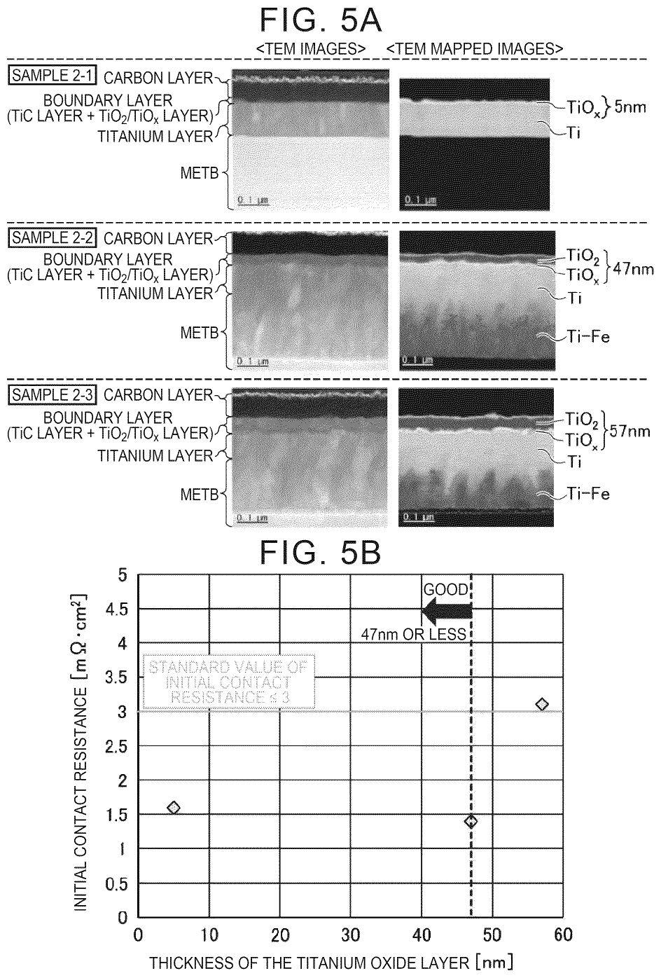

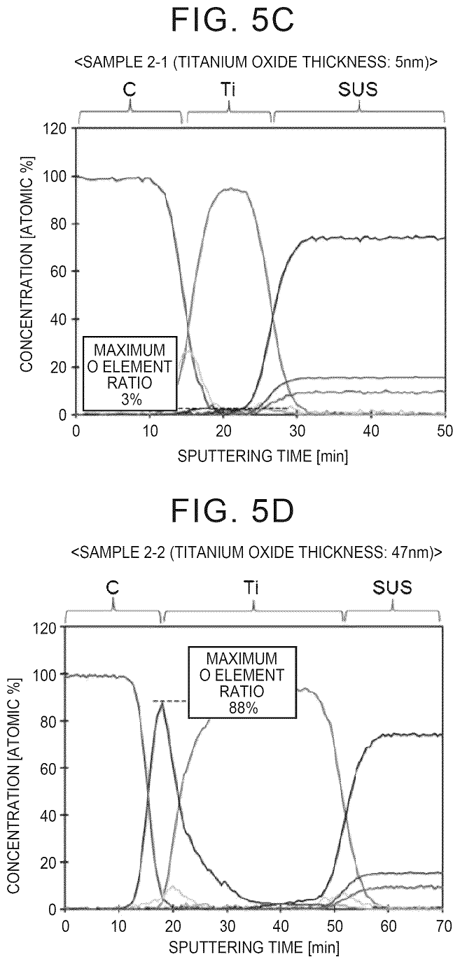

FIG. 5A is a photograph showing a TEM view image and an EELS map image of a cross section of a titanium-layer and a carbon-layer in a convex portion of a flow passage shape for the separators of Samples 2-1 to 2-3. FIG. 5B is a graphical representation of the change in contact-resistance of the separators of Samples 2-1 through 2-3 with respect to the thickness of the titanium-oxide layers. FIG. 5C shows AES depth profile of the separator of Sample 2-1, and FIG. 5D shows AES depth profile of the separator of Sample 2-2. As shown in FIGS. 5A and 5B and Tables 1 to 3, when the thickness of the titanium oxide layer (TiOₓ layer and the total thickness of TiO₂ layer) was less than or equal to 47 nm, the initial contact-resistance was within the specification. Further, as shown in 5C and 5D, when the thickness of the titanium oxide layer is equal to or less than 47 nm, in the border area between the titanium layer and the carbon layer, the O (oxygen) element ratio in the thickness direction is 88 atomic % or less, so that it is considered that the conduction path is sufficiently secured. Therefore, in the separator, the thickness of the titanium oxide layer is 47 nm or less, and the thickness of the titanium oxide layer is 47 nm or less, so that the conduction pass is sufficiently secured, and therefore, it is considered that the contact-resistance can be sufficiently reduced.

### Relationship Between the Orientation Ratio of the Crystal Lattice Plane and Fe Elution Rate

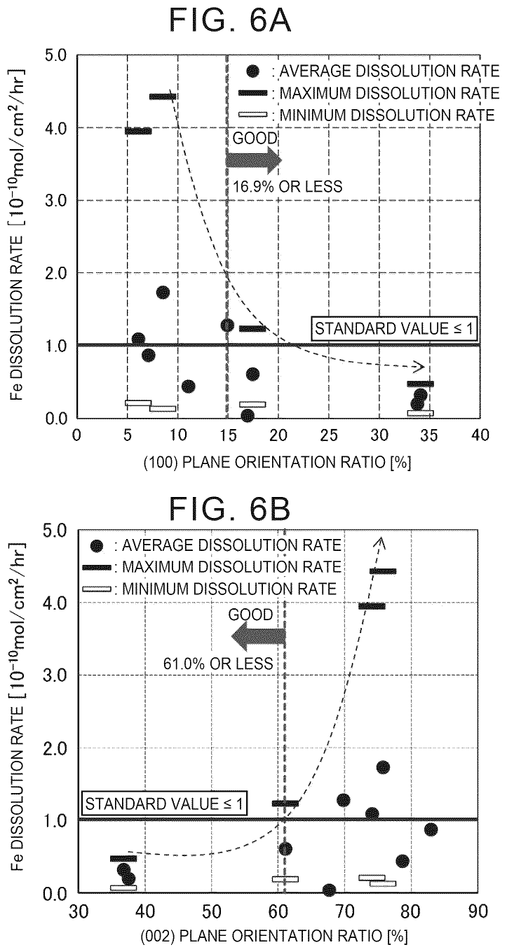

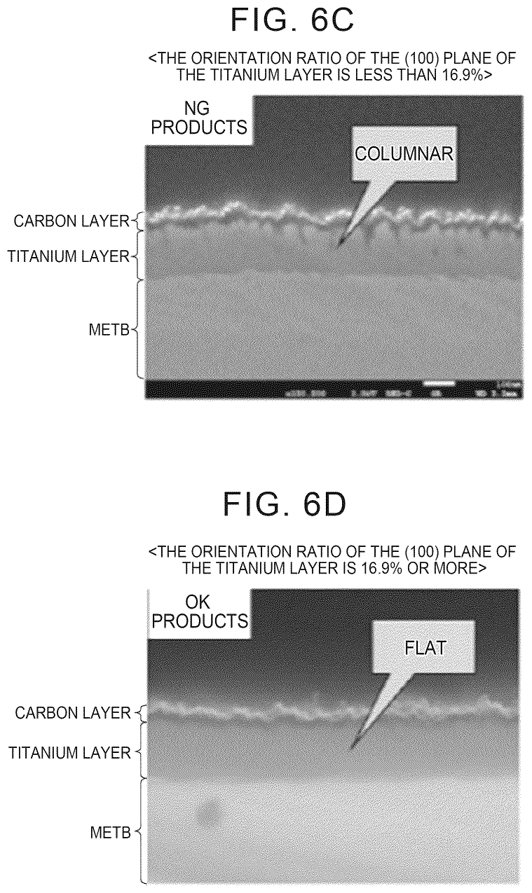

FIG. 6A is a graph showing the relationship between the orientation ratio of the (100) surface of the titanium layer of each separator of Samples 3-1 to 3-10 and Fe elution rate of a plurality of samples of each separator, and FIG. 6B is a graph showing the relationship between the orientation ratio of the (002) surface of the titanium layer of each separator of Samples 3-1 to 3-10 and Fe elution rate of a plurality of samples of each separator. In the FIGS. 6A and 6B, when two or more samples of the plurality of (3, 13, or 4) samples of each separator showed substantially the same Fe elution rate, only the average elution rate was represented, and when two or more samples of the plurality of samples of each separator showed different Fe elution rates, the average elution rate, the maximum elution rate, and the minimum elution rate were represented.

As shown in 6A and 6B, when the orientation ratio of the (100) plane of the titanium-layer was 16.9% or more, Fe elution rate of the separators stably decreased in all of the mean elution rate, the maximal elution rate, and the minimal elution rate. Fe dissolution rates of the separators were stably decreased at all of the mean dissolution rate, the maximal dissolution rate, and the minimal dissolution rate when the (002) plane orientation of the titanium-layer was less than or equal to 61.0%. From the viewpoint of corrosion resistance of the separator, it is considered that the orientation ratio of the (100) plane of the titanium layer is good at 16.9% or more, and the orientation ratio of the (002) plane of the titanium layer is good at 61.0% or less.

FIG. 6C and FIG. 6D are SEM observed images of a cross section of a sample in which the orientation ratio of the (100) surface of the titanium layer is less than 16.9% and a sample in which the orientation ratio of the (100) surface of the titanium layer is 16.9% or more. As shown in 6C and 6D, in the sample in which the orientation ratio of the (100) plane of the titanium layer is less than 16.9%, the titanium layer has a columnar structure with many defects, whereas in the sample in which the orientation ratio of the (100) plane of the titanium layer is 16.9% or more, the titanium layer has a flat structure with few defects.

Although the embodiment of the fuel cell separator according to the present disclosure has been described in detail above, the present disclosure is not limited to the above-described embodiment, and various design changes can be made without departing from the spirit of the present disclosure described in the claims.

What is claimed is:

1. A fuel cell separator comprising:
a metal substrate;
a titanium layer provided on the metal substrate; and
a carbon layer provided on the titanium layer, wherein
a boundary region between the titanium layer and the carbon layer has a TiC content of 70% or less.

2. The fuel cell separator according to claim 1, wherein a D-band peak intensity (I_{D}) and a G-band peak intensity (I_{G}) in a Raman spectrum of the carbon layer have an intensity ratio (I_{D}/I_{G}) of 0.7 or more.

3. The fuel cell separator according to claim 1, wherein a titanium oxide layer in the boundary region between the titanium layer and the carbon layer has a thickness of 47 nm or less, or an O element ratio in the boundary region between the titanium layer and the carbon layer has a maximal value of 88 atomic percent or less.

4. The fuel cell separator according to claim 1, wherein a (100) surface of the titanium layer has an orientation ratio of 16.9% or more, and a (002) surface of the titanium layer has an orientation ratio of 61.0% or less.
